(19) United States
(12) Patent Application Publication
(10) Pub. No.: US 2003/0204453 A1
(43) Pub. Date: Oct. 30, 2003

(54) Store-shelf allocation management system and information processing apparatus

(75) Inventor: Hiroshi Kawamata, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/269,962

(22) Filed: Oct. 15, 2002

(30) Foreign Application Priority Data
Apr. 30, 2002 (JP) 2002-128178

(51) Int. Cl. G06F 17/60

(52) U.S. Cl. 705/28

(57) ABSTRACT

The present invention is intended to provide a store-shelf allocation management system which is capable of performing a creation of a shelf allocation diagram by wirelessly reading merchandise item information written into supertags attached to merchandise items on respective shelves. The store-shelf allocation management system comprises: an information processing apparatus 10 adapted to create and store a shelf allocation information about store shelves; a display device 30 with a touch-sensitive panel function adapted to display thereon a shelf allocation diagram based on the shelf allocation information; and a tag reader 40 adapted to wirelessly read a data from a supertag attached to a merchandise item every the store shelf. In response to an instruction inputted on a screen image displayed by the display device with the touch-sensitive panel function, it is possible to create a shelf allocation diagram by using the stored shelf allocation information and the data read from the supertag via the tag reader. Furthermore, it is possible to perform a variety of merchandise item management processings (an inspection of the number of merchandise items, an inspection of a sell-by date, an inspection of a misplacement and the like) and then to display its processed result on the display device with the touch-sensitive panel function.

### BACKGROUND OF THE INVENTION

1. Field of the Invention

The present invention relates to a store-shelf allocation management system and, in particular, relates to a store-shelf allocation management system and information processing apparatus which are configured to automatically perform placement and inspection of merchandise items with respect to respective store-shelves in order to improve an efficiency in workability in a store.

2. Description of the Related Art

Data on the sales of individual stores like franchise stores such as convenience stores is almost managed by a headquarter. It often happens that the headquarter instructs individual stores on store-shelf allocations dependent on a sales state thereof. To the contrary, in response to a request from the headquarters, individual stores manually create their shelf allocation diagrams and/or take photographs of their shelves to transmit the photographs to the headquarters. Furthermore, an inspection of a merchandise item is performed by reading a bar-code attached to the merchandise item using a handy terminal.

However, it is impossible for a conventional system as mentioned above to identify the store-shelf allocation in a short time while it is not efficient to spend a superfluous time on an instruction issued from the headquarters. Also, the inspection must be performed per each merchandise item so that a very large amount of time would be spent for completing such an inspection. In particular, as a store becomes larger in scale, so this problem becomes more significant or difficult.

These problems and deficiencies in the conventional system are recognized and overcome by improved store-shelf allocation management system and information processing apparatus disclosed below. Thus, an object of the present invention is to provide a store-shelf allocation management system and an information processing apparatus which automatically perform a creation of a shelf allocation diagram and an inspection of a merchandise item by attaching a tag (inclusive of a semiconductor chip) to each merchandise item, each tag having written therein an information of an merchandise item to which the tag is attached, and then reading the information through a wireless transmission from the tags.

### SUMMARY OF THE INVENTION

According to the present invention, there is provided a store-shelf allocation management system, comprising:

an information processing apparatus adapted to create and store a shelf allocation information on a merchandise item store-shelf;

a display device adapted to display a shelf allocation diagram based on the shelf allocation information;

an instruction input section adapted to receive an input of a predetermined instruction; and

a tag reader adapted to wirelessly read the merchandise item data from a plurality of tags with corresponding merchandise item store-shelf thereof, each of said tags being attached to merchandise item with data of the merchandise item;

wherein, based on an instruction from the instruction input section, the information processing apparatus performs a merchandise item management by using the stored shelf allocation information and the data wirelessly read from the tags via the tag reader, thereby commanding the display device to display thereon the result of the merchandise item management.

By virtue of the configuration as described above, the information processing apparatus is able to activate the tag readers for reading the tags of merchandise items in each merchandise item shelf so that the shelf allocation diagram showing a layout of merchandise items in respective merchandise item shelves can automatically be created and then the created shelf allocation diagram can be displayed on the display device in a short time. Therefore, the present invention allows a user to give any instruction by using this shelf allocation diagram, as a result of which it is possible to automatically manage various merchandise items by using the shelf allocation information stored in the information processing apparatus and the tag data read via the tag readers.

According to the present invention, the display device and the instruction input section are configured by a display device with a touch-sensitive panel function so as to facilitate an input operation.

In addition, the tag reader is arranged every merchandise item shelf and capable of reading the merchandise item data only from the tags in its corresponding merchandise item shelf By virtue of such a simplified configuration, the merchandise item management can be facilitated by the information processing apparatus.

Furthermore, the information processing apparatus is capable of issuing a tag corresponding to the shelf allocation information by using a tag issuance device coupled to the information processing apparatus. By virtue of such a configuration, the information processing apparatus can efficiently perform a tag issuance because the information processing apparatus has the stored shelf allocation information.

Also, the information processing apparatus is adapted to acquire the shelf allocation information through a transmission line from a shelf allocation issuing source. By virtue of such a configuration, an instruction from the shelf allocation issuing source such as the headquarter can be transmitted to each of the stores without a remarkable influence of dependency on a distance from the source to the store.

Also, the information processing apparatus is adapted to display a sales state of merchandise item on the display device upon receipt of an information on sales of the store from a POS system. Furthermore, the information processing apparatus is adapted to, upon receipt of the information on sales of the store from the POS system, display merchandise items with a salable or unsalable aptitude.

Also, the information processing apparatus is adapted to perform the inspection of merchandise items in the merchandise item shelf based on the information on sales of the store from the POS system and the merchandise item data read by the tag reader. By virtue of such a configuration, it is possible to comprehend the state of a store stock and the like in real time because the information processing apparatus operates in conjunction with the POS system.

Also, the inspection according to the present invention includes at least one of an inspection of the number of items, an inspection of a sell-by date and an inspection of misplacement.

Also, the inspection can selectively be performed for an individual merchandise item or all of merchandise items and repetitively performed at adjustable time intervals.

Furthermore, the information processing apparatus is adapted to, upon receipt of an information on the price of a merchandise item, display said information on an electronic card of a merchandise item shelf on which the merchandise item is arranged. By virtue of such a configuration, it is possible to accurately and rapidly change settings of the price and the like of a merchandise item in each shelf.

Also, according to another aspect of the present invention, there is provided an information processing apparatus, comprising:

store-shelf allocation information creating means for creating a shelf allocation information on a merchandise item store-shelf;

shelf allocation information storing means for storing said shelf allocation information created by said shelf allocation information creating means;

management means for, based on an instruction from an instruction input section adapted to receive an input of a predetermined instruction, performing a merchandise item management by using the stored shelf allocation information and merchandise item data wirelessly read via a tag reader from tags each retaining such a merchandise item data.

These and other aspects of the present invention will be apparent from the following specific description, given by way of example, with reference to the accompanying drawings.

### BRIEF DESCRIPTION OF THE DRAWINGS

FIG. 1 is a schematic block diagram showing a store-shelf allocation management system of an embodiment according to the present invention;

FIG. 2 is a schematic block diagram showing a supertag issuance device as shown in FIG. 1;

FIG. 3 illustrates a format of a supertag issued by the supertag issuance device as shown in FIG. 2;

FIG. 4 is a schematic layout for explaining how tag readers of FIG. 1 are arranged in store shelves;

FIG. 5 illustrates an electronic shelf card arranged in each of the store-shelves;

FIG. 6 is a flow chart showing a first exemplary operation performed until a predetermined step for embodying a store-shelf allocation management system according to the present invention;

FIG. 7 illustrates a task selection screen image which is displayed on a display device with a touch-sensitive panel function during the exemplary operation of FIG. 6;

FIG. 8 illustrates an initial screen image which is displayed on the display device with the touch-sensitive panel finction when a store-shelf management is selected on the screen image as shown in FIG. 7;

FIG. 9 illustrates a screen image which appears upon selection of a function key for creating a store-shelf allocation displayed in a menu;

FIG. 10 illustrates a screen image which appears upon selections of a function key for an inspection of individual store-shelf and a shelf key for lunches 1;

FIG. 11 is a flow chart showing a second exemplary operation performed until a predetermined step for embodying a store-shelf allocation management system according to the present invention;

FIG. 12 illustrates an initial screen image which is displayed on the display device with the touch-sensitive panel function upon a selection of the store-shelf management on the task selection screen image;

FIG. 13 illustrates a screen image which appears upon a selection of a function key for the shelf allocation creation in the menu as shown in FIG. 12;

FIG. 14 illustrates a screen image of an inspection of individual merchandise item which appears when a key of the inspection of individual shelf is depressed and then a shelf key for fresheners 2 is depressed;

FIG. 15 is a flow chart showing a third exemplary operation based on an instruction from the headquarter;

FIG. 16 is a flow chart showing a fourth exemplary operation in association with a trade name/price display which is commenced from the step of a headquarter instruction for a shelf allocation display of FIG. 15 and then applied onto an electronic shelf card;

FIG. 17 is a flow chart showing a fifth exemplary operation to be performed for a label print, not for an application of the trade name/price display onto the electronic shelf card;

FIG. 18 illustrates an initial screen image which is displayed on the display device with the touch-sensitive panel function when the shelf management is selected on the task selection screen image and then a shelf allocation instruction is issued from the headquarter;

FIG. 19 illustrates an initial screen image which is displayed on the display device with the touch-sensitive panel function when the instruction is issued from the headquarter on the screen image of FIG. 18;

FIG. 20 illustrates a shelf allocation screen image to be displayed when a key of the shelf allocation instruction from the headquarter is selected on the screen image of FIG. 19;

FIG. 21 illustrates a detailed shelf allocation screen image to be displayed when a shelf key is selected on the screen image of FIG. 19 or FIG. 20;

FIG. 22 illustrates a screen image to be displayed when a function key of a label print is selected on the screen image of FIG. 21;

FIG. 23 is a flow chart showing an inspection operation as a sixth exemplary operation which is commenced from the final step of FIG. 6 or FIG. 11;

FIG. 24 illustrates a screen image to be displayed when a sell-by date is checked in the inspection operation of FIG. 23; and

FIG. 25 is a screen image for illustrating a time setting of time intervals for automatically repeating the inspection operation of FIG. 23.

### DESCRIPTION OF PREFERRED EMBODIMENTS

Hereinafter, preferred embodiments of the present invention will be described in detail with reference to the accompanying drawings.

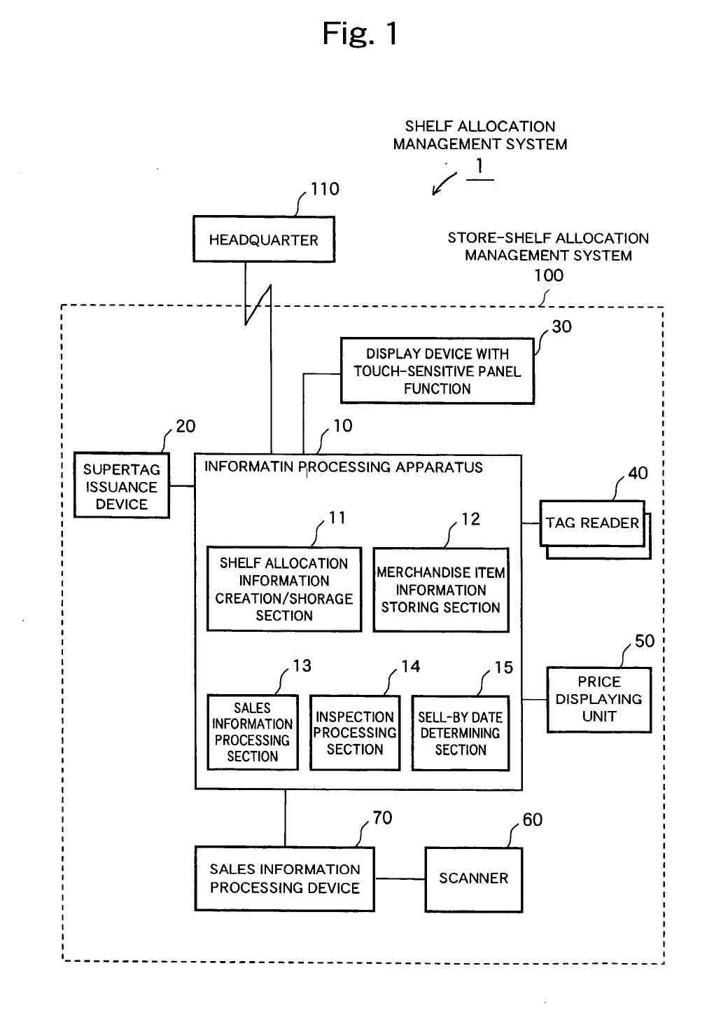

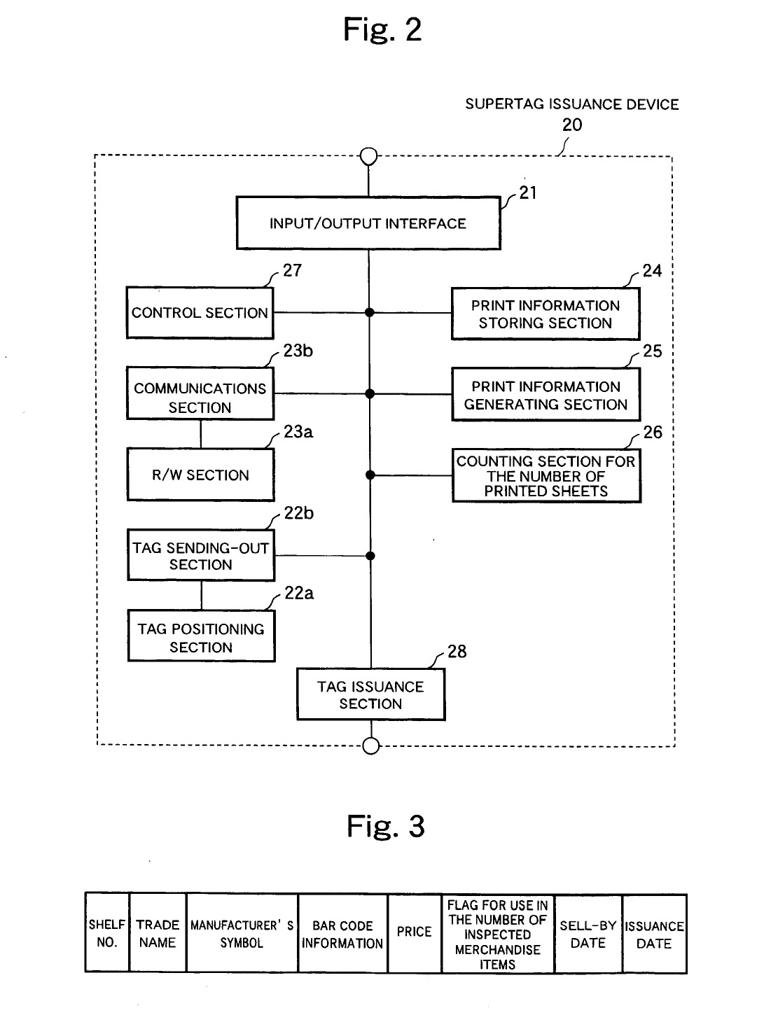

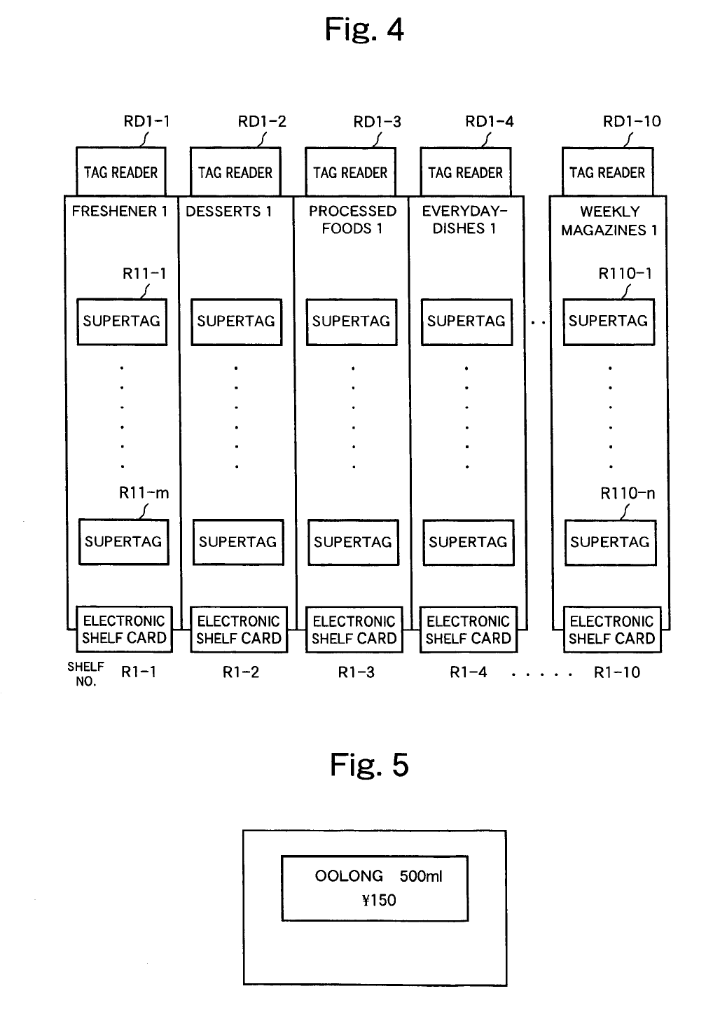

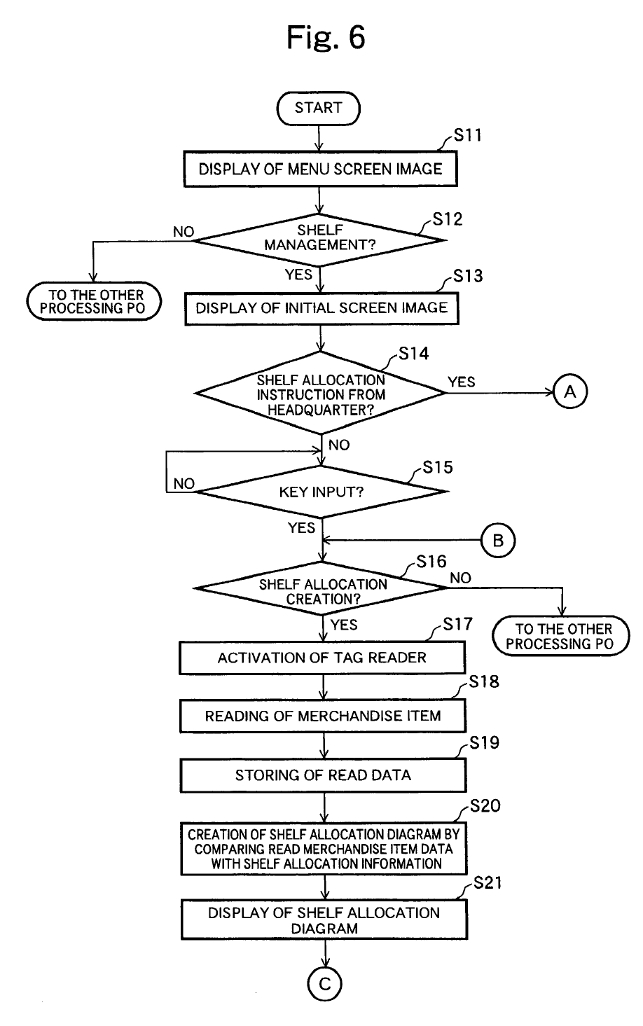

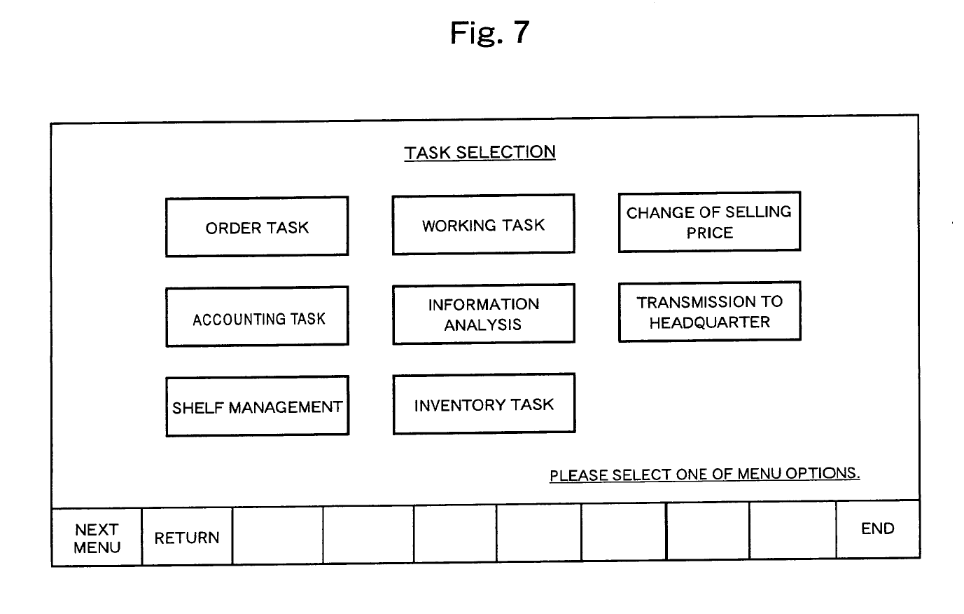

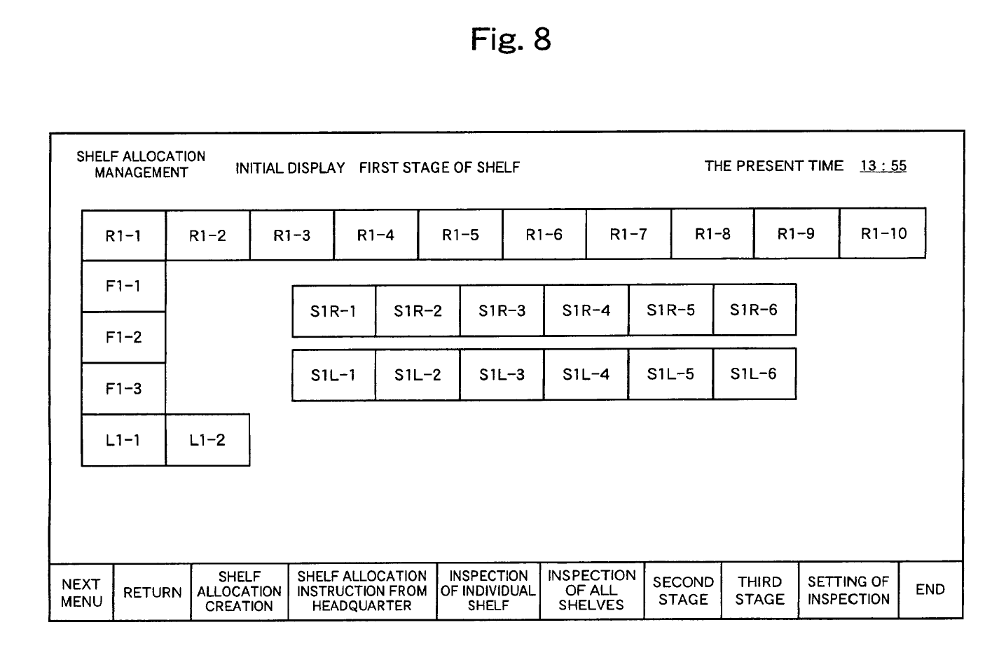

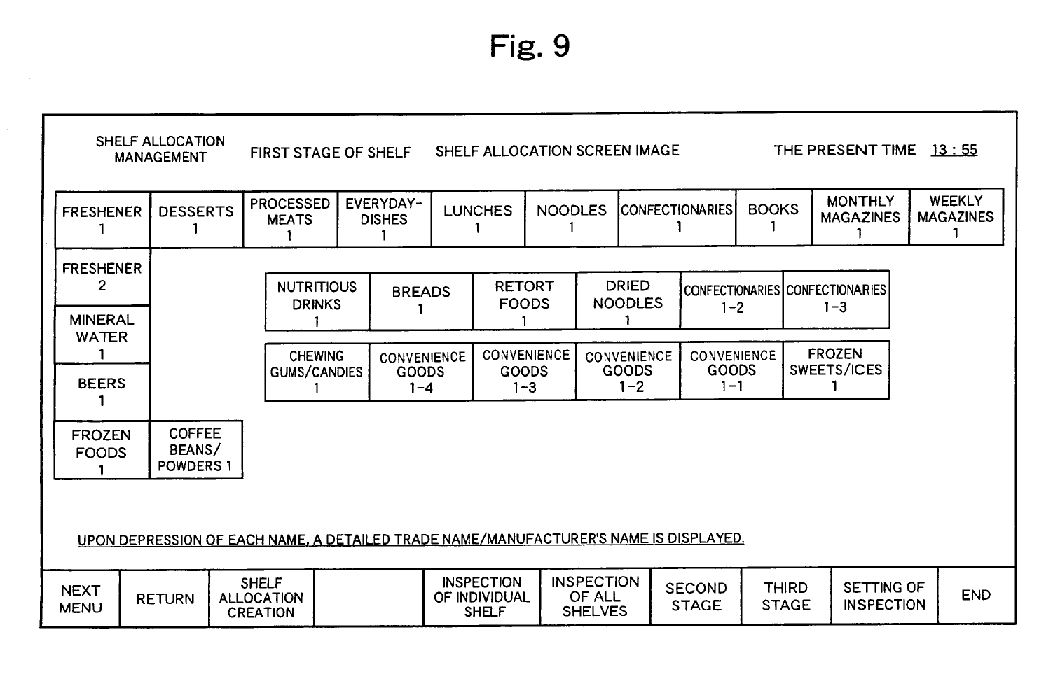

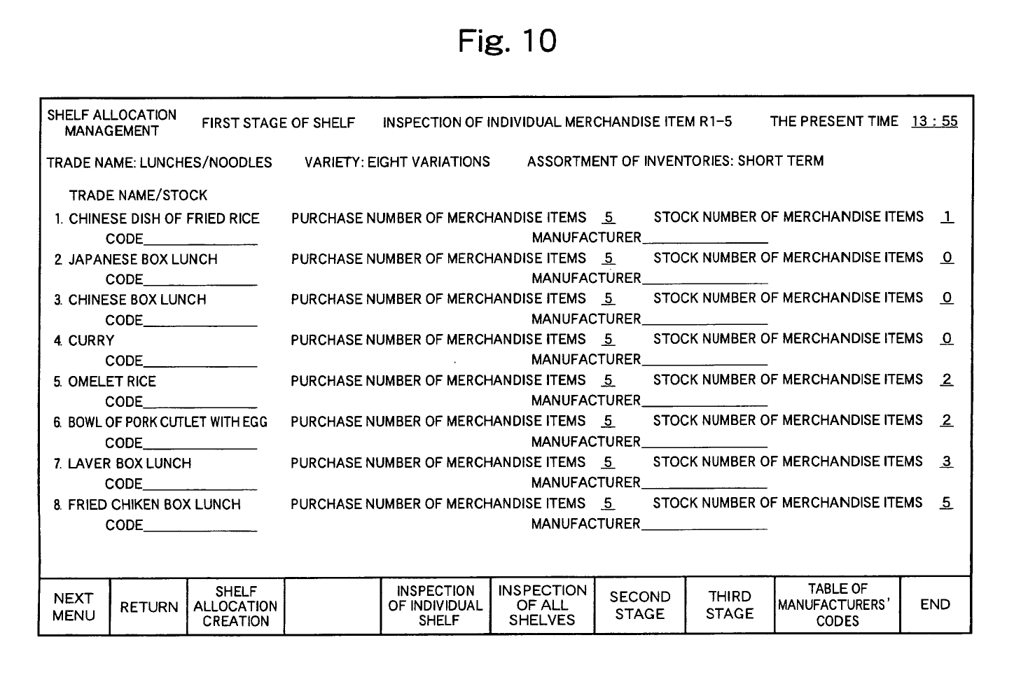

FIG. 1 is a schematic block diagram showing a store-shelf allocation management system of an embodiment according to the present invention; FIG. 2 is a schematic block diagram showing a supertag issuance device as shown in FIG. 1; FIG. 3 illustrates a format of the supertag issued by the supertag issuance device as shown in FIG. 2; FIG. 4 is a schematic layout for explaining how tag readers of FIG. 1 are arranged in store shelves; FIG. 5 illustrates an electronic shelf card arranged in each of the store-shelves; FIG. 6 is a flow chart showing a first exemplary operation performed until a predetermined step for embodying a store-shelf allocation management system according to the present invention; FIG. 7 illustrates a task selection screen image which is displayed on a display device with a touch-sensitive panel function during the exemplary operation of FIG. 6; FIG. 8 illustrates an initial screen image which is displayed on the display device with the touch-sensitive panel function when a store-shelf management is selected on the screen image as shown in FIG. 7; FIG. 9 illustrates a screen image which appears upon selection of a function key for creating a store-shelf allocation displayed in a menu; and FIG. 10 illustrates a screen image which appears upon selections of a function key for an inspection of individual store-shelf and a shelf key for lunches 1.

The store-shelf allocation management system as shown in FIG. I comprises a store-shelf allocation management system 100 and a headquarter 110 which is a source for issuing a store-shelf allocation information. In general, the headquarter 110 is connected through communication lines to a plurality of store-shelf allocation management systems 100, but only one store-shelf allocation management system 100 is illustrated in FIG. 1 for the purpose of simplification. The store-shelf allocation management system 100 comprises: an information processing apparatus 10; a supertag issuance device 20 (as referred to in FIG. 2); a display device 30 with a touch-sensitive panel function; a tag reader 40 (as referred to in FIG. 4); a price displaying unit 50 (as referred to in FIG. 5); a scanner 60; and a sales information processing apparatus 70. As shown in FIG. 1, the information processing apparatus 10 comprises: a shelf allocation information creating/storing section 11; a merchandise item information storing section 12; a sales information processing section 13; an inspection processing section 14; and a sell-by date determining section 15, and activates the display device 30 with the touch-sensitive panel function to display thereon practicable various task processings such that, based on one of the processings selected on a screen image of the display device, its processing is performed.

As shown in FIG. 2, the supertag issuance device 20 comprises: an input/output interface 21; a tag positioning section 22a and tag sending-out section 22b; an R/W section 23a and communications section 23b; a print information storing section 24; a print information generating section 25; a counting section 26 for counting the number of printed sheets; a control section 27; and a tag issuance section 28, as well as a label printer (not shown). Since a print instruction is given to the label printer for performing a label printing at the same time at which a super tag is issued, so only a super tag issuance will be described hereinafter.

In the supertag issuance device 20, the control section 27 controls the input/output interface 21 for receiving and storing in the print information storing section 24 an instructed data (which is a data concerning a supertag issuance by the supertag issuance device 20 based on an instruction from the information processing apparatus 10). Regarding a supertag installed in the R/W section 23a, the control section 27 also controls the tag positioning section 22a through the tag sending-out section 22b to be activated for fixedly positioning the supertag in a predetermined position of the R/W section 23a. Furthermore, the control section 27 transfers the data stored in the print information storing section 24 to the print information generating section 25 to generate a data which is properly formatted (as shown in FIG. 3) to be recorded in the supertag (and the label if there is present an instruction for label printing).

The control section 27 controls the print information generating section 26 to transmit the data formatted as mentioned above into the communications section 23b for supplying the R/W section 23a with the data to be written thereinto, while controlling the counting section 26 for counting the number of printed sheets to confirm the instructed number of printed sheets. After the writing operation is completed, one supertag is discharged from the tag issuance section 28 to terminate a supertag issuance (and a label issuance if there is present such an instruction). The supertag as referred to in this specification is a tag which is attached to each of merchandise items and which is equipped with a built-in IC chip for generating power in the IC chip by receiving an electromagnetic wave from the tag reader and capable of itself sending a stored information. The display device 30 with the touch-sensitive panel function is capable of displaying thereon a screen image for selective one of various task processings based on an instruction from the information processing apparatus 10. Specifically, this display device 30 with the touch-sensitive panel function receives an instruction from a user through a function key included in a menu displayed on the screen or a shelf key of the shelf-allocation diagram.

The tag reader 40 is designed to wirelessly read the contents of supertags attached to respective merchandise items on a store shelf. The tag reader can be arranged in various ways, but first of all an easily comprehensible arrangement way in which each tag reader is disposed on one of stages of every shelf will be described. There may be located plurality of shelves in the a store, the tag readers which are arranged in such a way and in conjunction with 10 shelves of the plurality of shelves will be described in reference with FIG. 4. Each of the 10 store-shelves may be divided into a plurality of stages (e.g., 3 stages) and first stages of the 10 store-shelves are designated as Shelf Nos. R1-1, R1-2, . . . , R1-10, respectively, as shown in FIG. 4. On upper-most portions of these first stages corresponding to the shelf Nos. R1-1, R1-2, . . . , R1-10 are placed tag readers RD1-1, RD1-2, ,RD1-10. It would be appreciated that the tag readers are not limited to being placed on the upper-most portions of the first stages. For example, each of the tag readers may be arranged such that the tag reader can read the supertags of respective shelves by appropriately positioning its antenna or the like. In this embodiment, merchandise items such as freshener 1, desserts 1, processed foods 1, everyday-dishes 1, . . . , weekly magazines 1 are arranged in the shelves Nos. R1-1, R1-2, . . . , R1-10, respectively, as shown in FIG. 4. For example, the merchandise items belonging to the fresheners 1 have supertags R11-1, R11-2, . . . , R11-Rm attached to themselves, the merchandise items belonging to the weekly magazines 1 have supertags R110-1, R110-2, . . . , R110-m (and labels in the usual ways).

When the information processing apparatus 10 gives reading instructions to the tag readers RD1-1, RD1-2, . . . , RD1-10, each of the tag readers reads supertags of merchandise items on its corresponding shelf and sends its read information to the information processing apparatus 10. For example, if a reading instruction is given to a tag reader RD1-10 on the first stage of the tenth shelf from the information processing apparatus 10, the tag reader RD1-10 read the contents of the supertags R110-1, R110-2, . . . , R110-n and send such read information to the information processing apparatus 10. In this way, the information processing apparatus 10 can confirm that merchandise items belonging to the weekly magazines 1 are correctly placed on the first stage of the tenth shelf as previously defined.

In the embodiment as described above, there are placed the tag readers on each stage of each shelf. However, the present invention is not limited to that arrangement. For example, a tag reader may be placed on an upper-most portion of a shelf having therein three stages so as to read all of supertags on respective stages of that shelf. Also, antennas may be placed on stages of a shelf, respectively, so as to read a supertag on a desired stage of those stages by switching the antennas from one to another. Furthermore, one tag reader may be placed for all supertags in all shelves of a store so as to read a desired supertag by switching antennas from one to another. In response to an instruction from the information processing apparatus 10, the price displaying unit 50 activates each of electronic shelf cards disposed at lower portions of the first stages of the shelf Nos. R1-1, R1-2, . . . , R1-10 to display thereon a trade name, price and like of merchandise item in its corresponding shelf. Each of the electronic cards is of a shape as shown in FIG. 5 and capable of displaying a name of item, price and the like on its liquid crystal display or the like. Also, the scanner 60 and the sales information processing apparatus 70 constitute a POS system so as to supply an sales information within a store to the sales information processing section 13 of the information apparatus 10.

Next, in order to perform the task processing, a first exemplary operation of the information processing apparatus of the store-shelf allocation management system as shown in FIG. 1 will be described with reference to a flow chart of FIG. 6.

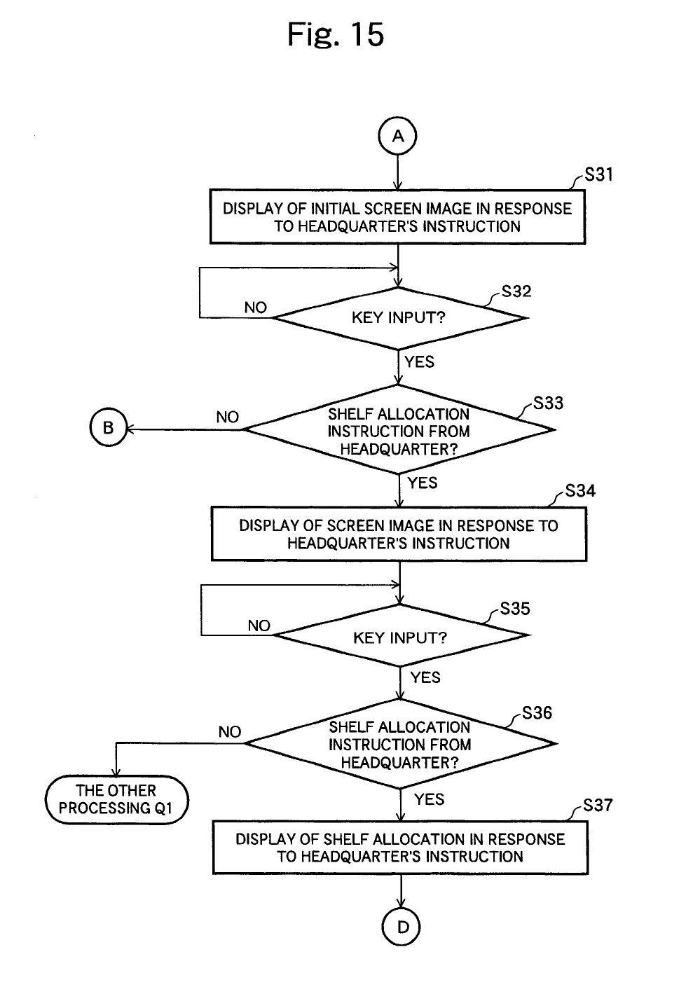

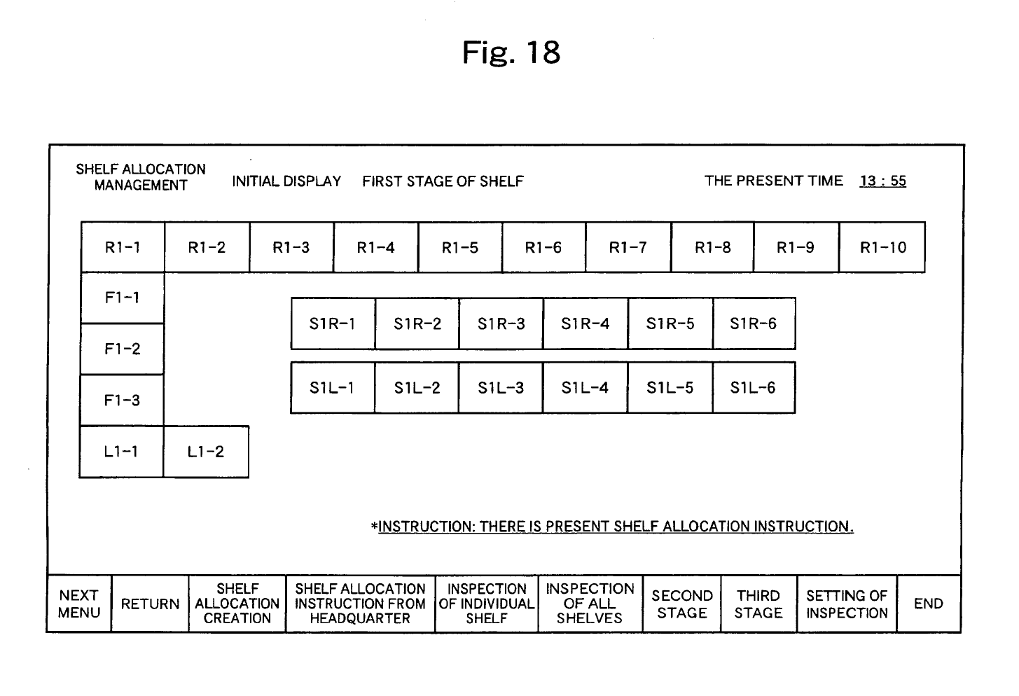

Upon activation of the store-shelf allocation management system 100, the information processing apparatus 10 activates or commands the display device with the touch-sensitive function 30 to display thereon a screen image of a task selection as shown in FIG. 7 in step 11 and decides in step 12 whether or not a “shelf management” key has been depressed on the displayed task selection screen image. If it can be decided that the “shelf management” key has been depressed, the information processing apparatus 10 commands the display device 30 to display thereon an initial screen image of FIG. 8 which is stored in the shelf allocation information creating/storing section 11 in step 13. So, the information processing apparatus 10 decides whether there has been a shelf allocation instruction from the headquarter 110 in step 14. If there is present such a shelf allocation instruction as referred to FIG. 18, the flow proceeds to a processing of a third exemplary operation to execute the shelf allocation instruction (A of FIG. 6, referred to the flow chart described later on as shown in FIG. 15). If there is no shelf allocation instruction, the information processing apparatus 10 decides whether any one of keys has been depressed in step 15. If any one of keys has been depressed, it is decided in step 16 whether such a depressed key is a “shelf allocation creation” key.

If so (the “shelf allocation creation” key has been decided as being the depressed one in step 16), the information processing apparatus 10 activates the tag reader 40, e.g., the tag readers RD1-1, RD1-2, . . . , R1-10 associated with the shelves R1-1, R1-2, . . . , R1-10 as shown in FIG. 4 in step 17, so as to read the supertags attached to respective merchandise items in step 18. Accordingly, it becomes clear that which of the merchandise items is placed on which of the shelves, as a result of which the information processing apparatus 10 can store data thus read in the merchandise item information storing section 12 in step 19. Thus, the information processing apparatus 10 creates a shelf allocation diagram (denoting which of merchandise items is placed in which of the shelves) by comparing the merchandise item data stored in the merchandise item storing section 12 with the shelf allocation information as shown in FIG. 8 (step 20), and then commands the display device 30 with the touch-sensitive panel function to display thereon the created shelf allocation diagram in step 21.

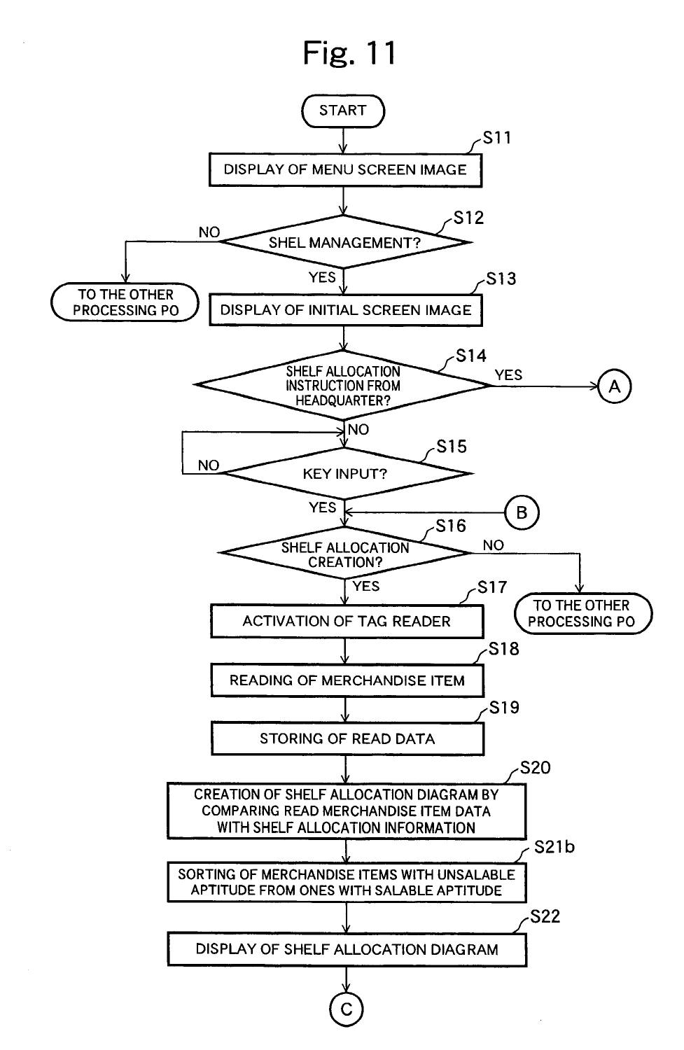

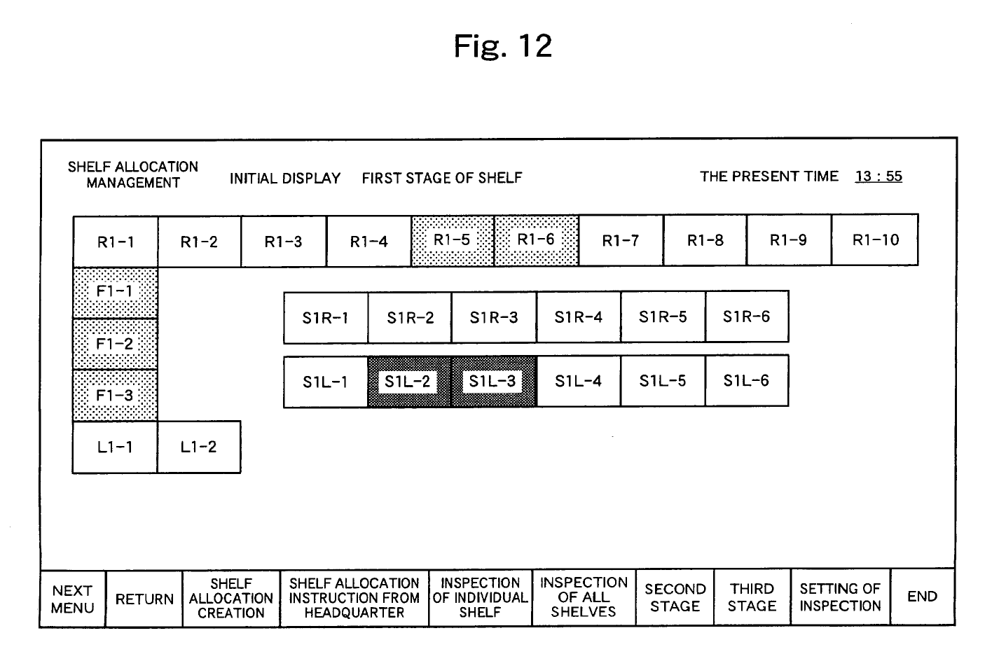

Next, a second exemplary operation of the information processing 10 will be described with reference to FIG. 11. This second exemplary operation is intended to display on the screen image as illustrated in the first exemplary operation (as shown in FIG. 8 or 9) merchandise items with a salable aptitude and merchandise items with an unsalable aptitude. It should be noted that steps 11 through 20 as shown in FIG. 11 are the same as those of steps 11 through 20 as shown in FIG. 6. After the completion of the processing of step 20, the information processing apparatus 10 sorts merchandise items as rank A, B, C in the order of higher salable aptitude, divides them into unsalable merchandise items as rank 1 with an unsalable aptitude, and standard merchandise items as rank 0, respectively, by linking with the sales information of the sales information processing section 13. Subsequently, the information processing apparatus 10 activates or commands the display device 30 to display thereon such an initial screen image as being shown in FIG. 12 (step 22).

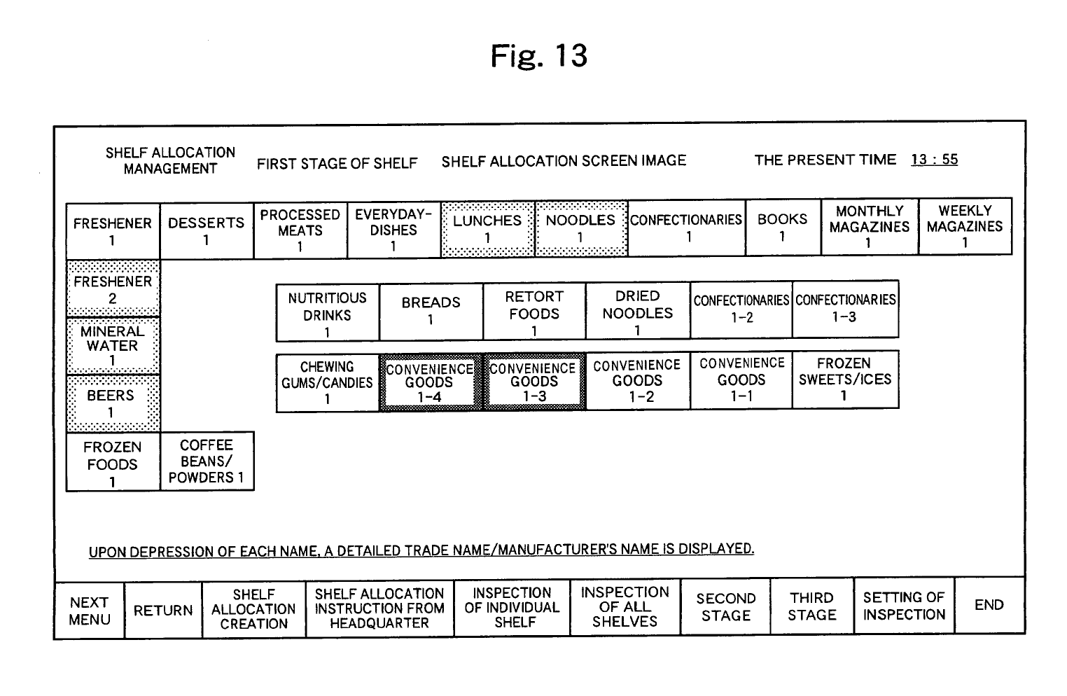

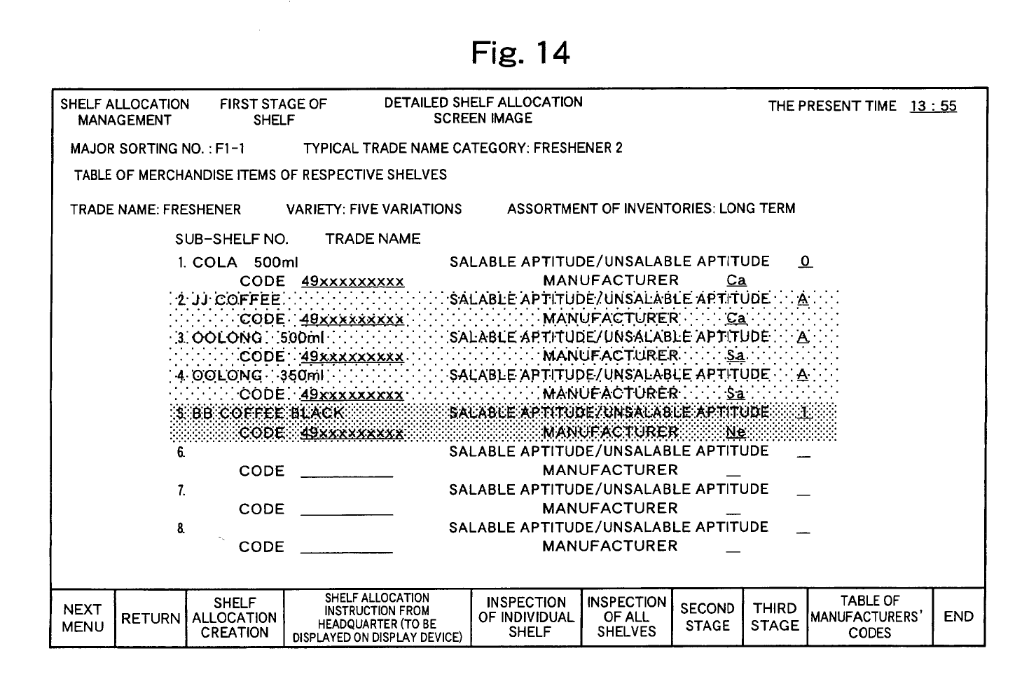

In FIG. 12, shelves F1-1, F1-2, F1-3, R1-5, R1-6 are identified as shelves for merchandise items each with a salable aptitude as denoted by salable mark (lightly shaded box) while shelves S1L-2, S1L-3 identified as shelves for merchandise items each with an unsalable aptitude as denoted by an unsalable mark (heavily shaded box). Then, if a “shelf allocation creation” key is depressed, the shelf allocation diagram with salable and unsalable marks is displayed as shown in FIG. 13. In FIG. 13, if an “inspection of individual shelf” key is depressed and any merchandise item key, e.g., a freshener 2 (as shown in FIG. 13 or a shelf F1-1 as shown in FIG. 12) key is depressed, a screen image of an “individual inspection F1-1” is displayed along with salable and unsalable marks as shown in FIG. 14. In this screen image, it is adjustable to display the purchase and stock numbers of merchandise items and their manufacturers' names. The first exemplary operation has been described above as a separate one from the second exemplary operation. However, if a “next menu” key is depressed after step 21 in the first exemplary operation of FIG. 6, the operation flow may be configured to proceed to step 21b of FIG. 11. If necessary after the depression of the “next menu” key, the operation flow may be configured to return to step 21.

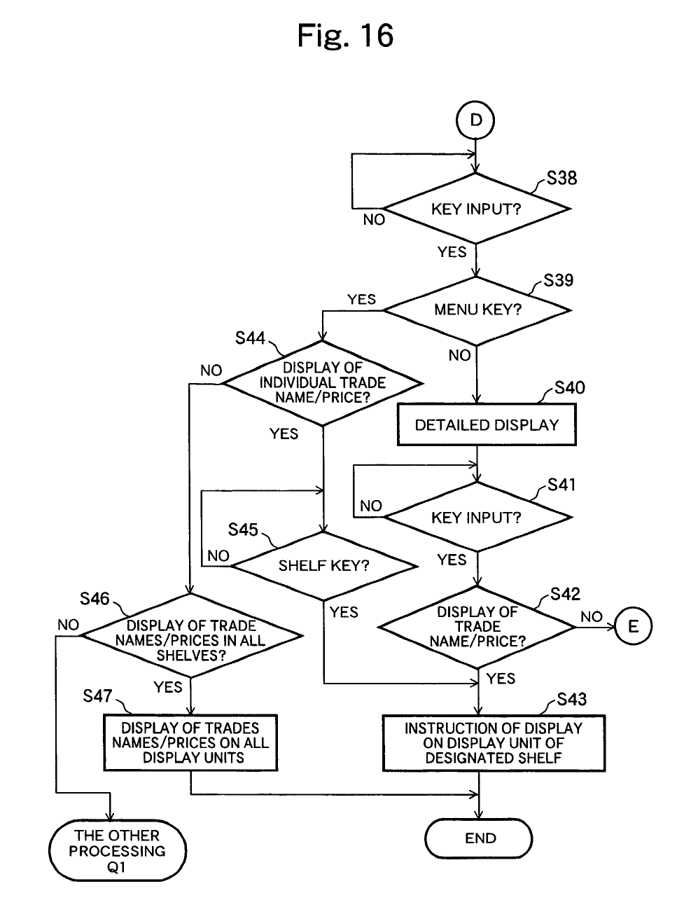

Next, a third exemplary operation upon a shelf allocation instruction from the headquarter 110 in step 14 of the first exemplary operation as shown in FIG. 6 (or in step 14 of the second exemplary operation as shown in FIG. 11) will be described with reference to flow charts as shown in FIGS. 15-17. When there is present the shelf allocation instruction sent from the headquarter 110, an initial screen image of the shelf allocation appears along with an additional display (winking if necessary) “*Instruction: there is present the shelf allocation instruction” and the third exemplary operation starts in step 31 of FIG. 15. In this initial screen image, the information processing apparatus 10 decides in step 32 whether there is present a key input. If so (i.e., there is present a key input), it is decided whether a “shelf allocation instruction from headquarter” key in a bottom row menu of FIG. 18 has been depressed.

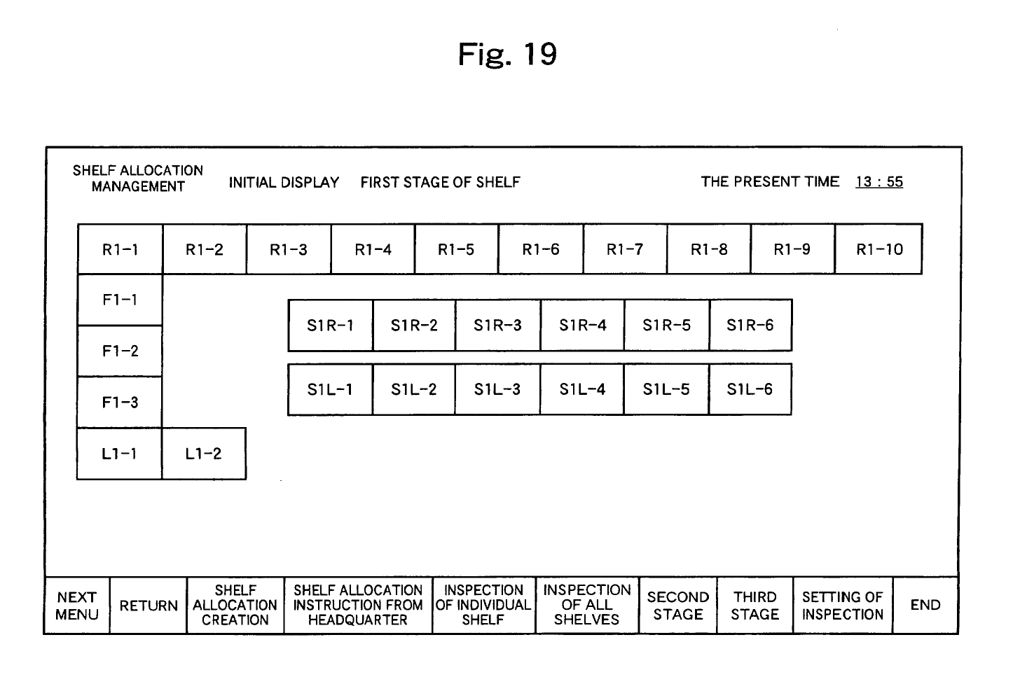

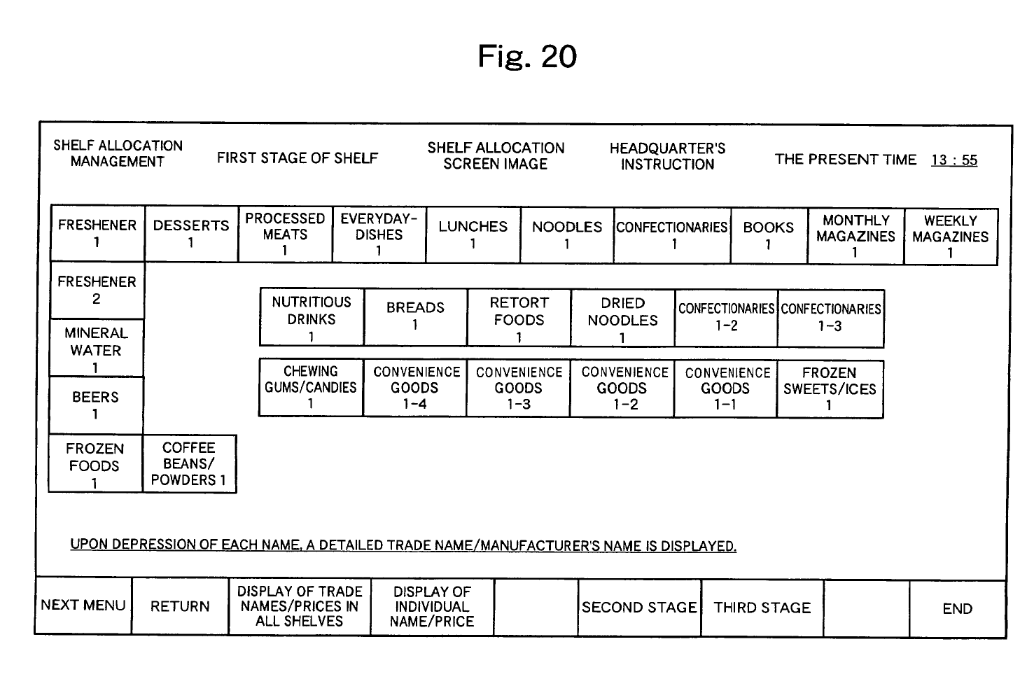

In the step 33 decision, if any other key, e.g., a “shelf allocation creation” key, than “shelf allocation instruction from headquarter” is depressed, this flow proceeds to a processing B in step 16 of FIG. 6 (or FIG. 11). However, if the “shelf allocation instruction from headquarter” key is depressed, the initial screen image of the shelf allocation according to the instruction from the headquarter is displayed in step 34 (in this embodiment, the initial screen image is a screen image as shown in FIG. 19 which is free from the display of “*Instruction: there is present the shelf allocation instruction” and whose contents are similar to those of FIG. 18). Then, the information processing apparatus 10 decides in step 35 whether a further key has been depressed. If so, the information processing apparatus 10 decides in step 36 whether the depressed key was a headquarter shelf allocation key or the other key. If the other key is depressed, this flow proceeds to the other processing Q1 in step 36. However, if the headquarter shelf allocation key is depressed, the information processing apparatus 10 commands the display device 30 to display a headquarter shelf allocation display given from the headquarter 110 as shown in FIG. 20 (step 37).

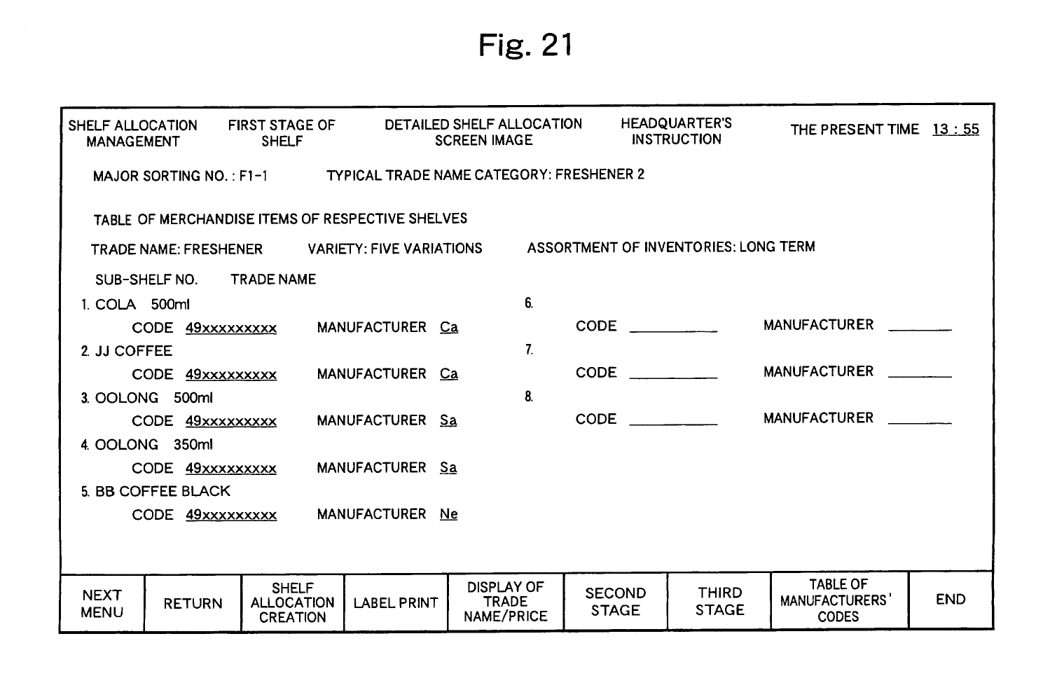

After the headquarter shelf allocation display, the information processing apparatus 10 proceeds to a processing (D) of a fourth exemplary operation and decides in step 38 whether any key input has been executed. If so, it is decided in step 39 whether any one of options in a bottom menu of the headquarter shelf allocation display (FIG. 20) has been depressed or any one of shelf keys has been depressed. In the case that any shelf key of a merchandise item shelf, e.g., a freshener 2 of FIG. 20 (or F1-1 of FIG. 19) has been decided as being the depressed one, a detailed shelf allocation screen image as shown in FIG. 21 is displayed in step 40. Subsequently, the information processing apparatus 10 decides in step 41 whether a further key input has been performed. If so, it is decided in step 42 whether a trade name/price display key or the other key has been depressed. In the case of the trade name/price display key input, the trade name and price will be displayed on an electronic shelf card of a shelf (F1-1) on which a merchandise item designated in step 40 (FIG. 21).

In step 39 as mentioned above, if any one of options in the menu keys at the bottom of the headquarter shelf allocation display (FIG. 20) has been decided as being the depressed one, the information processing apparatus 10 decides in step 44 whether an individual trade name/price display key has been depressed. If so (the individual trade name/price display key has been decided as being the depressed one in step 44), the information processing apparatus 10 decides in step 45 whether any one of shelf keys has been depressed. If so, the flow proceeds to step 43 and then a trade name/price of a merchandise item on a shelf corresponding to the depressed shelf key is displayed on an electronic card of the corresponding shelf. Also, if any other key than the individual trade/price display key has been decided as being the depressed one in step 44, the information processing apparatus 10 decides in step 46 whether an all-shelf name/price display key has been depressed. If any other key than the all-shelf name/price display key has been decided as being the depressed one, the flow proceeds to the other processing Q1. However, if the all-shelf name/price display key has been decided as being the depressed one, then trade names/prices of merchandise items on shelves are displayed on electronic cards of the all shelves in step 47.

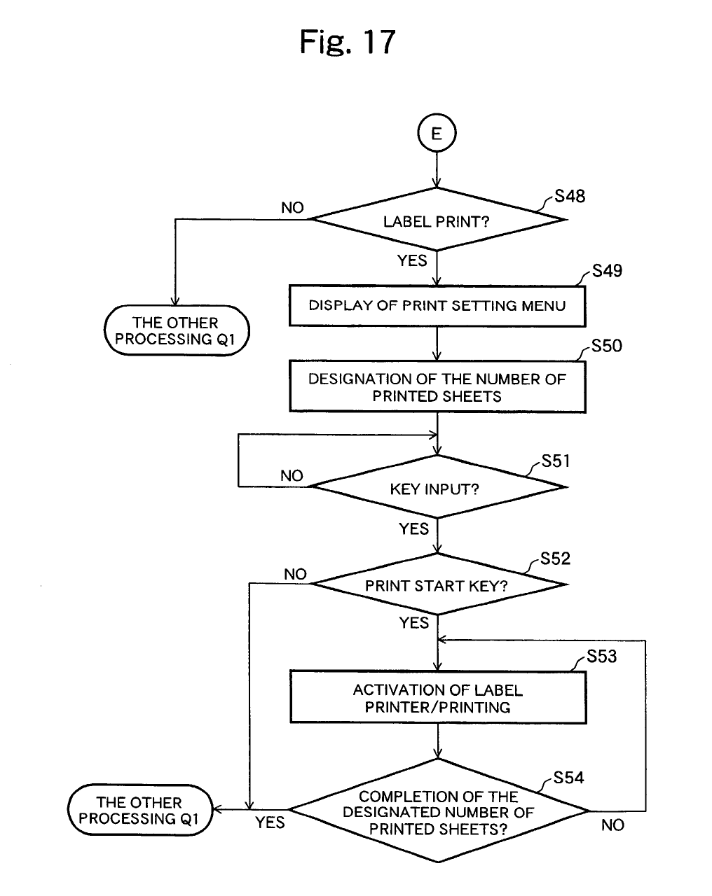

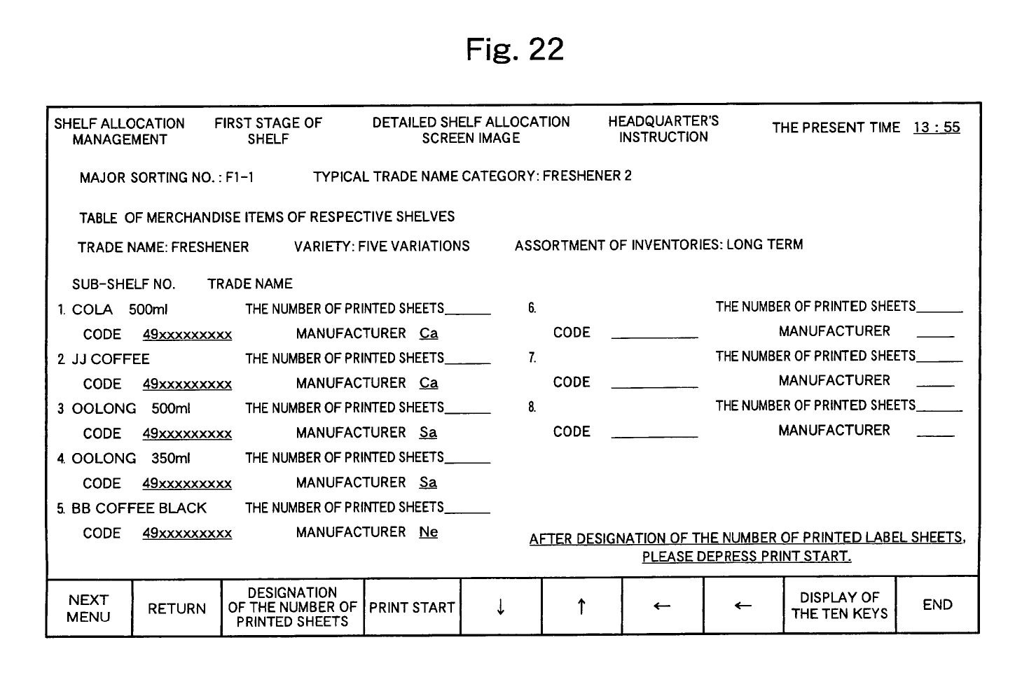

In step 42 as mentioned above, if there are present an input of any other key than the name/price display key for displaying the detailed shelf allocation screen image as shown in FIG. 21, the flow proceeds to a label print processing (E) as a fifth exemplary operation as shown in FIG. 17 and then the information processing apparatus 10 decides in step 48 whether a “label print” key has been depressed. If any other key than the “label print” has been decided as being the depressed one in step 48, the flow proceeds to the other processing Q1. However, if the “label print” key has been decided as being the depressed one in step 48, the information processing apparatus 10 commands the display device 30 with the touch-sensitive panel function in step 49 to display thereon a detailed shelf allocation screen image including a print-designation menu as shown in FIG. 22. Here, what is meant by the “label print” is a label print to be performed simultaneously with a supertag issuance by the supertag issuance device 20. Accordingly, such a supertag and a label will be prepared in the form of a pair to be attached each merchandise item.

As described above, a certain merchandise item is selected by appropriately using “↓”, “↑”, “←”, “→” keys on the detailed shelf allocation screen image of FIG. 22 displayed on the display device 30 and then a “designation for the number of sheets” key is depressed to designate the number of printed sheets in step 50. After the designation for the number of printed sheets, it is decided in step 51 whether there are present any key input. If there is present any key input, it is decided in step 52 whether that key input was a “print start” key. If that key input is not the “print start” key, the flow proceeds to the other processing Q1. However, if that key input is the “print start” key, a label printer of the supertag issuance device 20 is activated in step 53 to perform printing and it is decided in step 54 whether a designated number of printed sheets is completed. If completed, the flow proceeds to the other processing Q1. However, if not completed, the flow returns to step 53 for continuously printing.

After the screen image of the shelf allocation management which is described with reference to FIGS. 6 and 8 or FIGS. 11 and 12 is displayed, the information processing apparatus 10 proceeds to an inspection processing (C) (inclusive of a sell-by date management) as a sixth exemplary operation and then decides in step 55 whether an “inspection of individual shelf” keys has been depressed or the other key has been depressed. If the “inspection of individual shelf” key has been decided as being the depressed one, it is decided in step 56 which shelf key has been depressed. The tag reader corresponding to the depressed shelf key is activated in step 57 such that the number of supplied merchandise items (POS) and the current number of merchandise items are displayed in step 58. At this time, if a merchandise item is misplaced on a different shelf than its original or right shelf, a shelf number on which a tag reader or an antenna of the tag reader is disposed does not correspond to the different shelf number so that the merchandise item is displayed as a merchandise item of misplacement error (possibly along with an alarm sound if necessary) and omitted from an inspection number.

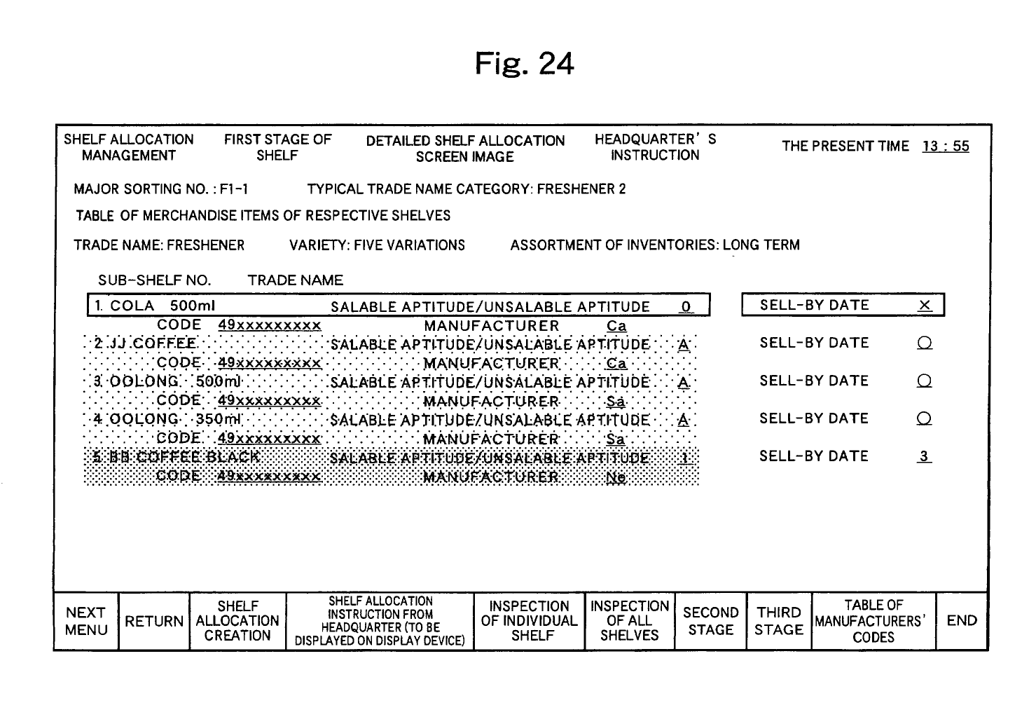

If a “next menu” key, for example, is depressed after the display of the number of supplied merchandise items and the current number of merchandise items, the flow proceeds to an operation for checking a sell-by date (it may be possible to automatically proceed to its sell-by date checking operation if there is no difference between the number of supplied merchandise items and the current number of merchandise items.). It is decided in step 59 whether there is present any merchandise item which is being displayed and which expires its sell-by date. If there is no merchandise item which expires its sell-by date, this flow is ended. However, if there is present any merchandise item which expires its sell-by date, it will be displayed on the display device 30 along with an alarm sound in step 60 as shown in FIG. 24. The screen image as shown in FIG. 24 is originated from FIGS. 11 and 12, wherein a sale aptitude of cola of a sub-shelf No. 1 is of standard “0” but its sell-by date is expired as denoted by “x”; a sell-by date for BB coffee black is expired in three days and denotes an unsalable aptitude “1”; and merchandise items of sub-shelves 2, 3, 4 denote their sell-by dates OK “◯” and are ones of the bestsellers with a salable aptitude “A”. Also, in the screen image of FIG. 8 or FIG. 9, if the “inspection of individual shelf” key is depressed and then any shelf key, e.g., a shelf key of a shelf R1-5 (lunches 1 of FIG. 8 or FIG. 9) is depressed, the screen image of the “individual inspection R1-5” is displayed as shown in FIG. 10 so that the purchase and stock numbers of merchandise items and manufacturer's name for the merchandise item are comprehensible.

If any other key than the “inspection of individual shelf” key is depressed in step 55 as mentioned above, it is decided in step 61 which of the “inspection of all shelves” key or the other key has been depressed. If the other key than the “inspection of all shelves” key has been decided as being the depressed one, the flow proceeds to the other processing Q1. However, if the “inspection of all shelves” key has been decided as being the depressed one, tag readers of all shelves are activated in step 62 and the number of supplied merchandise items and the current number of merchandise items of all shelves are displayed on the display device 30 with the touch-sensitive panel function in step 63. At this time, if a merchandise item is misplaced on a different shelf than its original or right shelf, a shelf number on which a tag reader or an antenna of the tag reader is disposed does not correspond to the different shelf number so that the merchandise item is displayed as a merchandise item of misplacement error (possibly along with an alarm sound if necessary) and omitted from an inspection number. If a “next menu” key, for example, is depressed after the display of the number of supplied merchandise items and the current number of merchandise items, the flow proceeds to an operation for checking a sell-by date. It is decided in step 64 whether there is present any merchandise item which is being displayed and which expires its sell-by date. If there is no merchandise item which expires its sell-by date, this flow is ended. However, if there is present any merchandise item which expires its sell-by date, it will be displayed on the display device 30 along with an alarm sound in step 65.

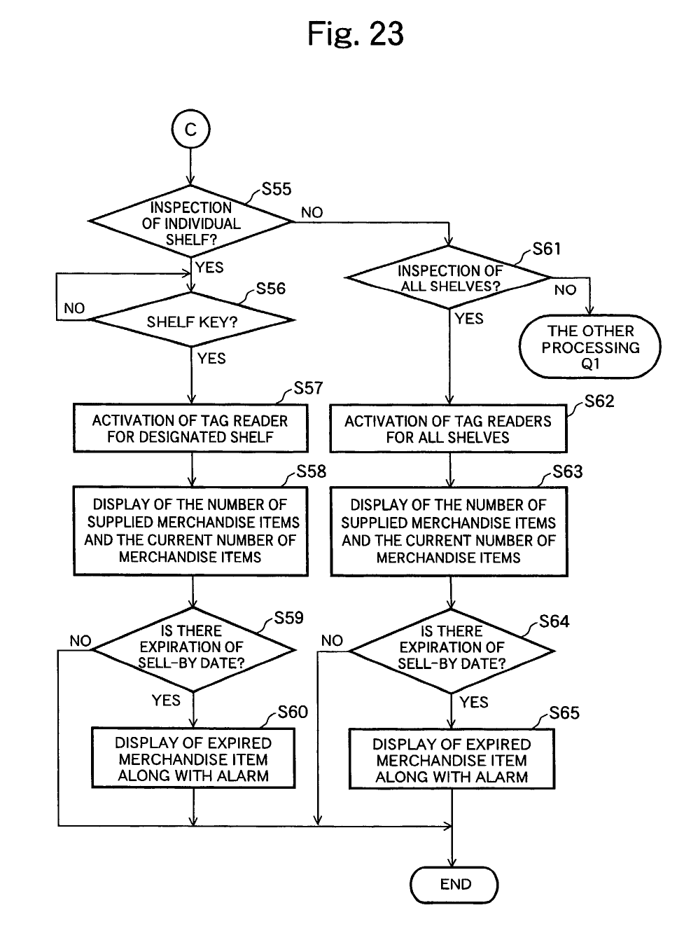

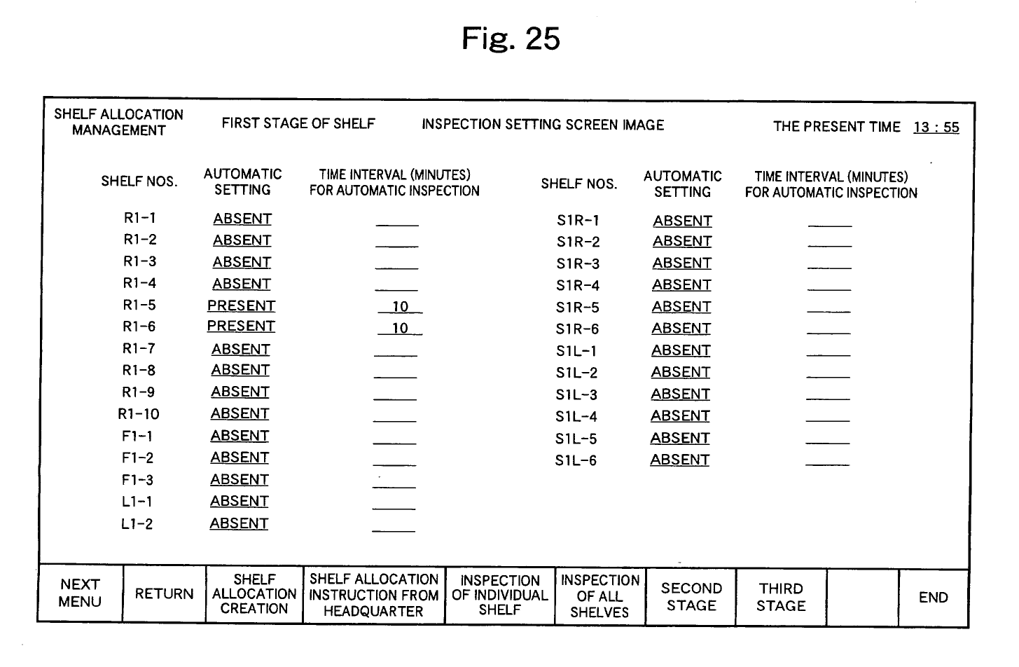

In the embodiment as described above, the inspection of merchandise item is manually performed as shown in FIG. 23. However, it is possible to automatically inspect a particular merchandise item or all of merchandise items and hereinafter such an automatic inspection will be described. For example, if an “inspection setting” key is depressed in the screen image as shown in FIG. 8 or FIG. 12, an inspection setting screen image of FIG. 25 is displayed on the display device 30 with the touch-panel function. If it is desired to perform the setting per shelf, an “inspection of individual shelf” key is depressed to designate shelf Nos. R1-5 and R1-6. If the automatic setting becomes “present”, then a time-interval article for the automatic inspection is designated as 10. Thus, merchandise items of the shelf Nos. R1-5 and R1-6 will automatically be inspected at ten-minute intervals. Also, if an “inspection of all merchandise items is depressed, all of the automatic settings become “present”. Then, if a desired time is inputted in any one of the time interval articles for the automatic inspection, then all of the time interval terms for the automatic inspection for all shelves are respectively filled with the desired time. Accordingly, the inspection of merchandise items of all shelves will automatically be performed at the desired time intervals.

Since the store-shelf allocation management system and the information processing apparatus according to the present invention are configured as above, the information processing apparatus is designed to activate the tag readers for reading the tags of merchandise items in each merchandise item shelf so that the shelf allocation diagram showing a layout of merchandise items in respective merchandise item shelves can automatically be created and then the created shelf allocation diagram can be displayed on the display device with the touch-sensitive panel function in a short time. Therefore, the present invention allows a user to give any instruction by using this shelf allocation diagram, as a result of which it is possible to automatically manage various merchandise items by using the shelf allocation information stored in the information processing apparatus and the tag data read via the tag readers. For example, it is possible to inspect in a short time an abnormality of the number of merchandise items disposed in its corresponding shelf and an expiration of a sell-by date for any merchandise item. Furthermore, by sending a shelf allocation information from a shelf allocation issuing source to a particular store, it is possible to give any instruction regarding the shelf allocation to the particular store in a short time.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A store-shelf allocation management system, comprising:
an information processing apparatus adapted to create and store a shelf allocation information on a merchandise item store-shelf;
a display device adapted to display a shelf allocation diagram based on said shelf allocation information;
an instruction input section adapted to receive an input of a predetermined instruction; and
a tag reader adapted to wirelessly read the merchandise item data from a plurality of tags with corresponding merchandise item store-shelf thereof, each of said tags being attached to merchandise item with data of the merchandise item;
wherein, based on an instruction from said instruction input section, said information processing apparatus performs a merchandise item management by using the stored shelf allocation information and the merchandise item data wirelessly read from the tags via said tag reader, thereby commanding said display device to display thereon the result of the merchandise item management.

2. A store-shelf allocation management system as claims in claim 1, further comprising a display device with a touch-sensitive panel function inclusive of said display device and said instruction input section.

3. A store-shelf allocation management system as claims in claim 1, wherein said tag reader is arranged every merchandise item shelf and capable of reading the merchandise item data only from said tags in its corresponding merchandise item shelf.

4. A store-shelf allocation management system as claims in claim 1, wherein said information processing apparatus is capable of issuing a tag corresponding to the shelf allocation information by using a tag issuance device coupled to said information processing apparatus.

5. A store-shelf allocation management system as claims in claim 1, wherein said information processing apparatus is adapted to acquire said shelf allocation information through a transmission line from a shelf allocation issuing source.

6. A store-shelf allocation management system as claims in claim 1, wherein said information processing apparatus is adapted to display a sales state of merchandise item on said display device upon receipt of an information on sales of said store from a POS system.

7. A store-shelf allocation management system as claims in claim 6, wherein the sales state of said merchandise item includes a display of merchandise items with a salable or unsalable aptitude.

8. A store-shelf allocation management system as claims in claim 1, wherein said information processing apparatus is adapted to perform an inspection of a merchandise item in said merchandise item shelf based on an information on sales of said store from said POS system and the merchandise item data read by said tag reader.

9. A store-shelf allocation management system as claims in claim 8, wherein said inspection includes at least one of an inspection of the number of items, an inspection of a sell-by date and an inspection of misplacement.

10. A store-shelf allocation management system as claims in claim 8, wherein said inspection is selectively performed for an individual merchandise item or all of merchandise item.

11. A store-shelf allocation management system as claims in claim 8, wherein said inspection is repetitively performed at adjustable time intervals.

12. A store-shelf allocation management system as claims in claim 1, wherein, upon receipt of an information on the price of a merchandise item, said information processing apparatus is adapted to display said information on an electronic card of a merchandise item shelf in which the merchandise item is arranged.

13. An information processing apparatus, comprising:
shelf allocation information creating means for creating a shelf allocation information on a store's merchandise item shelf;
shelf allocation information storing means for storing said shelf allocation information created by said shelf allocation information creating means;
management means for, based on an instruction from an instruction input section adapted to receive an input of a predetermined instruction, performing a merchandise item management by using the stored shelf allocation information and merchandise item data wirelessly read from tags each retaining merchandise item data via a tag reader.
